(19) United States
(12) Patent Application Publication
(10) Pub. No.: US 2004/0087741 A1
(43) Pub. Date: May 6, 2004

(54) Method for preparing halogenated polymers, and resulting halogenated polymers

(76) Inventors: Jean-Marie Blaude, Brussels (BE); Roland Martin, Brussels (BE); Jean-Marie Chauvier, Namur (BE); Charles Bienfait, Keerbergen (BE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/451,630

(22) PCT Filed: Dec. 24, 2001
(86) PCT No.: PCT/EP01/15211

(30) Foreign Application Priority Data
Jan. 10, 2001 (FR) 0100445
Jan. 29, 2001 (US) 60264312

(51) Int. Cl. C08F 2/00; C08G 85/00

(52) U.S. Cl. 526/65; 526/67; 526/88

(57) ABSTRACT

Process for the continuous preparation of halopolymers, comprising the radical-mediated polymerization of halomonomers in a medium comprising liquid or supercritical carbon dioxide in at least two mixed reactors under pressure in series. Halopolymers obtained.

The present invention relates to a process for preparing halopolymers and to the halopolymers obtained.

It is known practice to prepare fluoropolymers by polymerization in a medium comprising liquid or supercritical carbon dioxide according to a continuous process in a reactor with recovery of the fluoropolymer by flash decompression (WO 98/28051).

One of the drawbacks of this process is that the polymerization takes place under virtually unique conditions of temperature, pressure, density, constituent concentration and residence time. This drawback limits the degrees of freedom which allow the molecular mass distributions of the polymers thus produced to be controlled.

Another criticism which may be levelled at this prior art process is the difficulty it presents in controlling the degree of incorporation of various monomers and their arrangement in the halopolymers.

One aim of the present invention is thus to overcome these limitations by proposing a continuous process for preparing halopolymers in a medium comprising liquid or supercritical carbon dioxide.

According to the present invention, a process for continuously preparing halopolymers is proposed, comprising the radical polymerization of halomonomers in a medium comprising liquid or supercritical carbon dioxide in at least two mixed reactors under pressure in series.

Preferably, the process for continuously preparing halopolymers according to the invention comprises the radical polymerization of halomonomers in two mixed reactors under pressure in series.

For the purposes of the present invention, the terms monomers and polymers cover both the singular and the plural.

For the purposes of the present invention, the term “continuous process” is intended to denote a process in which the supply of carbon dioxide, monomers, initiators and additives and the withdrawal of the content of each from the reactors are carried out continuously. Preferably, the continuous process according to the invention is such that the control of the supplies, of the withdrawal and of the other polymerization conditions ensures stationary operating conditions for each of the reactors.

The process of the invention is carried out in a medium comprising carbon dioxide in liquid or supercritical form. The process according to the invention is preferably carried out in a medium comprising carbon dioxide in supercritical form.

In a particularly preferred manner, the polymerization conditions of the process in accordance with the present invention are controlled and adapted independently in each reactor.

The temperature in each of the reactors is usually at least −50° C., preferably at least −20° C., and in a particularly preferred manner at least 0° C. The temperature is usually not more than 200° C., preferably not more than 175° C. and in a particularly preferred manner not more than 150° C.

The pressure in each of the reactors is usually at least 5 bar, preferably at least 35 bar and in a particularly preferred manner at least 40 bar. The pressure is usually not more than 3 000 bar, preferably not more than 700 bar and in a particularly preferred manner not more than 500 bar.

The density of the medium in each of the reactors is usually at least 500 kg/m³, preferably at least 600 kg/m³. The density of the medium in each of the reactors is usually not more than 1 200 kg/m², preferably not more than 1 000 kg/m³.

One particular aspect of the process according to the invention is that the adjustment of the density of the medium makes it possible to control the mutual solubilities of the carbon dioxide, the monomers, the initiators and the additives, on the one hand, and of the halopolymers obtained, on the other hand.

In a most particularly preferred manner, the polymerization conditions in the first reactor are adapted so as to make the halopolymers obtained insoluble in the medium.

Another aspect of the process according to the present invention envisages, at least downstream of the final reactor, a step of purification of the halopolymer.

The purification of the halopolymer may be carried out using pure carbon dioxide or a mixture of carbon dioxide and of either pure or recycled monomers. Preferably, the purification is carried out using a mixture of carbon dioxide and of either pure or recycled monomers. In a particularly preferred manner, the purification is carried out using a mixture of carbon dioxide and of recycled monomers.

Another preferred aspect of the process according to the present invention also envisages, at least downstream of the final reactor, a step of recycling of the carbon dioxide and of the unconverted monomers.

This step of recycling of the carbon dioxide and of unconverted monomers may optionally be accompanied by a step of purification of the carbon dioxide and of the unconverted monomers.

This step of recycling of the carbon monoxide and of the unconverted monomers may also optionally be accompanied by a step of separation of one or more of the constituents of the carbon dioxide/unconverted monomers mixture so as to be able to recycle them separately.

Another particularly preferred aspect of the process according to the present invention envisages that the step of purification of the halopolymer and/or the step of recycling of the carbon dioxide and of the unconverted monomers should be preceded by a step of concentration of the suspension containing the halopolymer. This concentration operation may be carried out in any device which is suitable for this purpose, for example by means of filters, cyclones or any other device with a filtering, centrifuging or gravitational effect.

One most particularly preferred aspect envisages that, in the process according to the invention, at least one of the steps of purification of the halopolymer, of recycling of the carbon dioxide and of the unconverted Monomers, and of concentration of the suspension containing the halopolymer should be carried out at a pressure which is sufficiently close to those in the reactors to achieve these operations with a moderate recompression energy cost.

For the purpose of the present invention, the expression “radical-mediated polymerization of halomonomers” is intended to denote both the homopolymerization of halomonomers and their copolymerization with other ethylenically unsaturated monomers which may undergo radical-mediated polymerization, in order to obtain halopolymers.

For the purposes of the present invention, the term “halopolyrers” is intended to denote both homopolymers and copolymers of halomonomers. Among the latter, mention may be made in particular of homopolymers of halomonomers such as fluoroolefins, for example vinylidene fluoride, vinyl fluoride, trifluoroethylene, tetrafluoroethylene, chlorotrifluoroethylene and hexafluoropropylene; fluoroacrylates; fluorovinyl ethers, for example perfluorovinyl ethers bearing perfluoroalkyl groups containing from 1 to 6 carbon atoms; vinyl chloride and vinylidene chloride. Mention may also be made of the copolymers formed by these halomonomers with each other and the copolymers of one of these halomonomers with another monomer containing ethylenic unsaturation such as olefins, for example ethylene, propylene, styrene derivatives and styrene; haloolefins; vinyl ethers; vinyl esters such as, for example, vinyl acetate; acrylic acids, esters, nitrites and amides and methacrylic acids, esters, nitriles and amides.

The process for polymerizing the halomonomers according to the invention preferably applies to the polymerization of monomers containing fluorine in order to obtain polymers containing fluorine.

For the purposes of the present invention, the expression “polymers containing fluorine” is intended to denote both homopolymers and copolymers of monomers containing fluorine. Among the latter, mention may be made in particular of homopolymers of monomers containing fluorine such as fluoroolefins, for example vinylidene fluoride, vinyl fluoride, trifluoroethylene, tetrafluoroethylene, chlorotrifluoroethylene and hexafluoropropylene; and fluoroacrylates and fluorovinyl ethers, for example perfluorovinyl ethers bearing perfluoroalkyl groups containing from 1 to 6 carbon atoms. Mention may also be made of the copolymers formed by these monomers containing fluorine with each other, such as, for example, copolymers of vinylidene fluoride with another fluoromonomer as defined above and copolymers of one of the monomers containing fluorine mentioned above with another monomer containing ethylenic unsaturation, such as olefins, for example ethylene, propylene, styrene, derivatives and styrene; haloolefins; vinyl ethers; vinyl esters such as, for example, vinyl acetate; acrylic acids, esters, nitrites and amides and methacrylic acids, esters, nitriles and amides.

In a particularly preferred manner, the process for polymerizing halomonomers according to the invention applies to the polymerization of vinylidene fluoride in order to obtain vinylidene fluoride polymers.

For the purposes of the present invention, the expression “vinylidene fluoride polymers” is intended to denote both vinylidene fluoride homopolymers and its copolymers with other monomers containing ethylenic unsaturation, whether they are fluorinated (fluoroolefins, for example vinyl fluoride, trifluoroethylene, tetrafluoroethylene, chlorotrifluoroethylene, hexafluoropropylene; fluoroacrylates; fluorovinyl ethers such as, for example, perfluorovinyl ethers bearing perfluoroalkyl groups containing from 1 to 6 carbon atoms) or not (olefins such as, for example, ethylene; propylene; styrene derivatives and styrene; haloolefins; vinyl ethers; vinyl esters such as, for example, vinyl acetate; acrylic acids, esters, nitriles and amides; methacrylic acids, esters, nitriles and amides). The vinylidene fluoride homopolymers and the copolymers of vinylidene fluoride with a fluorine-containing comonomer are preferred. The vinylidene fluoride homopolymers and the copolymers of vinylidene fluoride and of chlorotrifluotoethylene and the copolymers of vinylidene fluoride and of hexafluoropropylene are particularly preferred. The copolymers obtained preferably contain at least 75% by weight of monomer units derived from vinylidene fluoride.

In the process according to the invention, the total concentration of monomers in each of the reactors is usually at least 0.5 mol/litre, preferably at least 1 mol/litre. The total concentration of monomers in each of the reactors is usually not more than 10 mol/litre, preferably not more than 6 mol/litre.

The polymerization process according to the invention is carried out via a radical route and usually involves the use of one or more initiators, whose nature, number and concentration may also be chosen independently in each reactor, according to need. As initiators that are useful in the context of the present invention, any suitable radical initiator may be used, in particular an organic radical initiator chosen, for example, from peroxides such as diethyl peroxydicarbonate, dicetyl peroxydicarbonate, dicyclohexyl peroxydicarbonate, bis(2-ethylhexyl) peroxydicarbonate, t-butyl peroxyisopropylcarbonate, t-butyl peroxy-n-decanoate, t-butyl peroxyacetate, di-t-butyl peroxide, dibenzoyl peroxide, dioctanoyl peroxide, dilauroyl peroxide, dicumyl peroxide, di-t-amyl peroxide, t-butyl per-2-ethylhexanoate, t-butyl peroxymaleate, cumene hydroperoxide, pinane hydroperoxide, p-menthane hydroperoxide; nitrites, such as 2,2′-azobis(methoxy-2,4-dimethylvaleronitrile) and 2,2′-azobis(2,4-dimethylvaleronitrile), and similar compounds.

The concentration of initiators in each of the reactors is usually between 5×10⁻⁵ mol/litre and 0.1 mol/litre.

The polymerization of the process of the present invention can optionally be carried out in the presence of one or more surfactants or of one or more dispersants. Any suitable surfactant or any suitable dispersant known to those skilled in the art may be used.

The process according to the invention may optionally be carried out in the presence of other additives such as the additives mentioned above (initiators, surfactants and dispersants) for improving the implementation of the process and/or the characteristics of the resulting polymer. Examples of other additives are chain-transfer agents, anti-encrustation agents, antistatic agents and co-solvents.

The polymerization step in accordance with the present invention is carried out in mixed reactors under high pressure. These mixed reactors may be of any type known to those skilled in the art, provided that they withstand the temperatures and high pressures required to perform the process.

For the purposes of the present invention, the term “Mixed reactor” denotes a reactor fitted with a mixing device which serves to homogenize the reaction medium such as, for example, paddle stirrers, screw stirrers or impeller stirrers. Each of the reactors may be of a different type.

These reactors may also be individually equipped with a heating system and/or a cooling system to control the temperature in each of the reactors. The temperature of the reactors will usually be controlled by a heat-exchange system consisting, for example, of a jacket or a heat exchanger inside the reactor, conveying a heat-exchange fluid. The heat released can be used to bring the reagents and (co)solvents downstream and/or upstream of the reactor under consideration to the required temperature.

Besides the independent temperature control, the process of the invention also allows the pressure density and other polymerization conditions to be adapted independently in each reactor, on the one hand, by controlling the flow rate and/or the pressure at the outlet of each reactor, for example by removing some of the product from the said reactor, and, on the other hand, by feeding each reactor with monomers, initiators, additives and/or carbon dioxide.

The present invention also relates to the halopolymers obtained by the process according to the invention.

The present invention also relates to halopolymers with bimodal or multimodal distribution of the molecular masses. Preferably, these halopolymers are characterized by a bimodal or multimodal distribution of the degree of incorporation of the monomers.

The present invention also relates to halopolymers with bimodal or multimodal distribution of the degree of incorporation of the monomers. These halopolymers may be characterized by a monomodal distribution or by a bimodal or multimodal distribution of the molecular masses. Preferably, these halopolymers are characterized by a bimodal or multimodal distribution of the molecular masses.

For the purposes of the present invention, the expression “distribution of the molecular masses” is intended to denote the distribution measured by steric exclusion chromatography.

For the purposes of the present invention, the distribution of the molecular masses is said to be unimodal if it can be described, in the case of an asymmetric distribution, by the relationship (1) or, in the case of a symmetrical distribution, by the relationship (2):

$$\begin{matrix}y = {a}_{0} exp \{ \frac{ln ( 2 ) {ln [ \frac{( x - {a}_{1} ) ( {a}_{3}^{2} - 1 )}{{a}_{2} {a}_{3}} + 1 ]}^{2}}{ln {a}_{3}^{2}} \} & [ 1 ] \\ y = \frac{{a}_{0}}{{a}_{1} {a}_{2} \sqrt{exp ( {a}_{2}^{2} )} \sqrt{2 π}} exp [ - \frac{1}{2} {( \frac{ln \frac{x}{{a}_{1}}}{{a}_{2}} )}^{2} ] & [ 2 ]\end{matrix}$$

The various symbols have the following meanings:

a₀: amplitude

a₁: mode

a₂: half-height width

a₃: form factor

y: =d(w)/d(logM)

x: =M

w: mass fraction of the polymer

M: molecular mass

Ln: Naperian logarithm

For the purposes of the present invention, the molecular mass distribution is said to be bimodal if it can, be described only by the combination of two sub-distributions according to relationship (1) arid/or (2), with a coefficient of determination of at least 0.99, the deconvolution of the bimodal distributions making it possible to quantity the mass proportions of each of the two sub-distributions by the area of the peaks. In the case of multimodal distributions, deconvolution is carried out by the combination of relationships (1) and/or (2) that are intrinsic to each of the sub-distributions.

For the purposes of the present invention, the expression “degree of incorporation of the monomers” is intended to denote the amounts, expressed as percentages, of the various monomers which constitute the halopolymer.

For the purposes of the present invention, the expression “bimodal or multimodal distribution of the degree of incorporation of each monomer” is intended to denote any mass distribution of this degree of incorporation which shows two or more modes.

The process and the polymers according to the invention have many advantages. Generally, the mechanical and theological properties of polymers usually depend not only on the average molecular masses and on the degree of incorporation of the various monomers into the polymer, but also on their complete distributions. The process according to the invention makes it possible to obtain halopolymers with bimodal or multimodal molecular mass distributions and/or bimodal or multimodal distributions of the degree of incorporation of the various monomers into the polymer chain. The optimization of distributions of this type makes it possible particularly to improve the processability and physical properties of the objects used. The process according to the invention is particularly advantageous in this respect, by virtue of a better control of the parameters and a more targeted control of the conditions under which the polymerization takes place in each of the reactors in series. The various components of the bimodal or multimodal distributions are obtained directly as an intimate mixture of the molecular scale, which makes the polymers obtained of higher quality than molten blends of different polymers with monomodal distributions of the molecular masses and of the degree of incorporation of the various monomers. The process according to the invention also makes it possible to vary the arrangement of the monomers in the polymer chain of the polymers obtained.

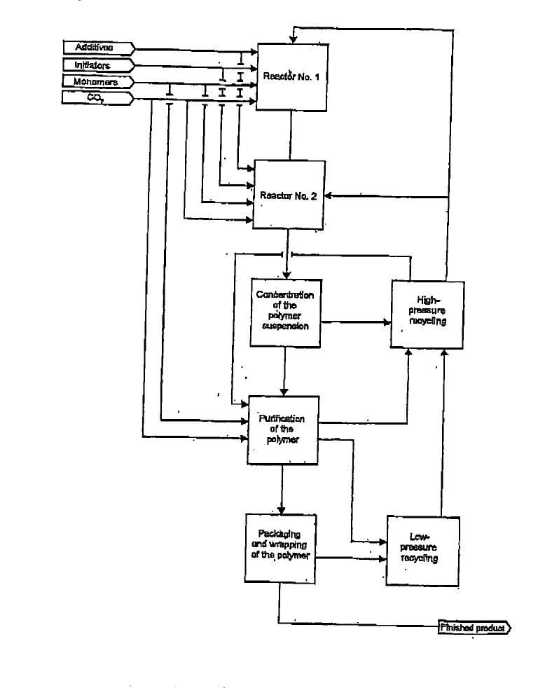

FIG. 1 illustrates the present invention without, however, limiting its scope. It represents a schematic view of one embodiment of the process according to the present invention for two reactors connected in series.

A first reactor is supplied continuously with carbon dioxide, initiators, monomers and additives; some of the carbon dioxide and unconverted monomers recovered downstream of the second reactor may also be recycled therein. Controlling the supplies into the first reactor makes it possible to control the residence time therein and the concentrations of the various constituents. The mixed state in the reactor is obtained by means of a suitable device. The beat of polymerization is used to bring the contents of the reactor to the reaction temperature, any excess heat being removed by circulating a cold fluid in a jacket or in a heat-exchange device located in the reactor. This allows the temperature of the first reactor to be controlled.

The contents of the first reactor comprising the polymer produced are emptied into the second reactor. This controlled emptying makes it possible to control the pressure of the first reactor. The second reactor can also be supplied with carbon dioxide, initiator, monomers and pure additives, as well as with the rest of the carbon dioxide and the unreacted monomers recovered downstream of the second reactor and recycled. Controlling the supplies to the second reactor makes it possible to control the residence time therein and the concentrations of various compounds which are different from the residence time and concentrations' prevailing in the first reactor. The temperature control of the second reactor follows the same principles as the temperature control of the first reactor, and makes it possible to impose upon it a temperature which is different from the temperature in the first reactor.

At the outlet of the second reactor, the suspension of polymer particles is emptied into a sector for concentrating the suspension containing the halopolymer. This controlled emptying makes it possible to control a pressure in the second reactor which is different from the pressure in the first reactor. The fluid (continuous phase) separated from the polymer suspension in the concentration sector is recycled at high pressure into the reactors or also conveyed at high pressure into a polymer purification sector.

The concentrated polymer suspension is then conveyed into a polymer purification sector, in which carbon dioxide and/or pure monomers may be used to free the polymer of residues of initiators, polymerization additives and by-products. The carbon dioxide and/or the monomers that are pure or recycled and are added for the purification, and also the carbon dioxide, monomers and unconverted monomers accompanying the polymer at the outlet of the suspension concentration sector, are then conveyed, according to their pressure level, either directly into the recycling sector at high pressure, or into a recycling sector at low pressure. The purified polymer is finally packaged and wrapped, constituting the finished product.

1. Process for the continuous preparation of halopolymers, comprising the radical-mediated polymerization of halomonomers in a medium comprising liquid or supercritical carbon dioxide in at least two mixed reactors under pressure in series,

2. Process according to claim 1, comprising the radical-mediated polymerization of halomonomers in two mixed reactors under pressure in series.

3. Process according to claim 1, in which a step of purification of the halopolymer is envisaged at least downstream of the final reactor.

4. Process according to claim 1, in which a step of recycling of the carbon dioxide and the unconverted monomers is envisaged at least downstream of the final reactor.

5. Process according to claim 1, in which the step of purification of the halopolymer and/or the step of recycling of the carbon dioxide and the unconverted monomers' is preceded by a step of concentrating the suspension containing the halopolymer.

6. Process according to claim 1, in which at least one of the steps of purification of the halopolymer, of recycling of the carbon dioxide and unconverted monomers, and of concentration of the suspension containing the halopolymer is carried out at a pressure which is sufficiently close to those in the reactors to achieve these operations with a moderate recompression energy cost.

7. Process according to claim 1, characterized in that the polymers obtained are polymers containing fluorine.

8. Process according to claim 1, characterized in that the polymers obtained are vinylidene fluoride polymers.

9. Halopolymers with bimodal or multimodal distribution of the molecular masses.

10. Halopolymers according to claim 9, characterized by a bimodal or multimodal distribution of the degree of incorporation of the monomers.

11. Halopolymers with bimodal or multimodal distribution of the degree of incorporation of the monomers.
